(19) United States
(12) Patent Application Publication
(10) Pub. No.: US 2008/0095962 A1
(43) Pub. Date: Apr. 24, 2008

(54) Sticker structure

(76) Inventor: Chiu-Hsiang Lee, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/584,006

(22) Filed: Oct. 20, 2006

(51) Int. Cl. B32B 33/00; B32B 9/04

(52) U.S. Cl. 428/40.1

(57) ABSTRACT

A sticker structure includes a transparent paper, a release paper of a back glue of which is printed with a pattern, and a simile paper which is printed with multiple variations of colors. The transparent paper is used as a bottom, the simile paper is used as a top, and they are fed in and printed at the same time. After the transparent paper and the simile paper are affixed together, the aligned stickers are constituted by forming once with a guillotine molding, to provide for an affixing at a side as an index, such that a data searching can be clearer and convenient, and the simile paper can be written with a water pen, thereby improving a practicability of the sticker. The release paper is provided with a weak glue of strong stickiness, such that the sticker can be affixed more firmly, and can be affixed repeatedly.

### BACKGROUND OF THE INVENTION

(a) Field of the Invention

The present invention relates to a sticker structure, and more particularly to a sticker structure which is convenient to be manufactured, can be used in multiple purposes, and can be written with a water pen.

(b) Description of the Prior Art

Referring to FIG. 1 and FIG. 2, in an ordinary sticker structure, a simile paper 11 printed with a color is first affixed to a side of a transparent sticker 12, and then is formed with a guillotine molding to constitute a plurality of repeatedly reusable color stickers on a bottom paper 13. As this kind of manufacturing method should be performed in a straight direction, an alignment, a combination, and an orientation of its printing are limited and thereby being difficult to print with multiple kinds of colors, which is not perfect at all. Referring to FIG. 3 and FIG. 4, for another kind of sticker, a color 22 is directly printed on a transparent sticker 21. Although multiple variations of colors can be formed, as paints are directly covered on the transparent sticker 21, the sticker cannot be written with an ordinary water pen but with an oil pen, which is not convenient in usage, and can cause an eco-problem due to a utilization of the oil pen.

### SUMMARY OF THE INVENTION

The primary object of present invention is to provide a sticker structure, such that a sticker used for reporting, indexing, or categorizing is provided with more practicability, and the sticker can be written with a water pen, thereby improving a convenience in usage.

The aforementioned sticker structure includes a release paper of transparent paper, a back side of which is printed with a pattern, and a simile paper on a top. The papers are fed in and printed at the same time, are affixed together, and then are formed once with a guillotine molding to constitute the aligned stickers.

In the aforementioned sticker structure, the back sides of transparent paper and bottom paper are all coated with a weak glue of a strong stickiness, such that the sticker can be more firmly affixed to different objects to prevent from an inadequate falling off, and can be affixed repeatedly.

For the aforementioned sticker structure, the simile paper and the transparent paper are fed in and printed at the same time, and they are not limited to an alignment, a combination, and an orientation of printed colors.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a perspective view of a conventional sticker.

FIG. 2 shows a local exploded view of FIG. 1.

FIG. 3 shows a perspective view of another conventional sticker.

FIG. 4 shows a local exploded view of FIG. 3.

FIG. 5 shows a perspective view of an embodiment of the present invention.

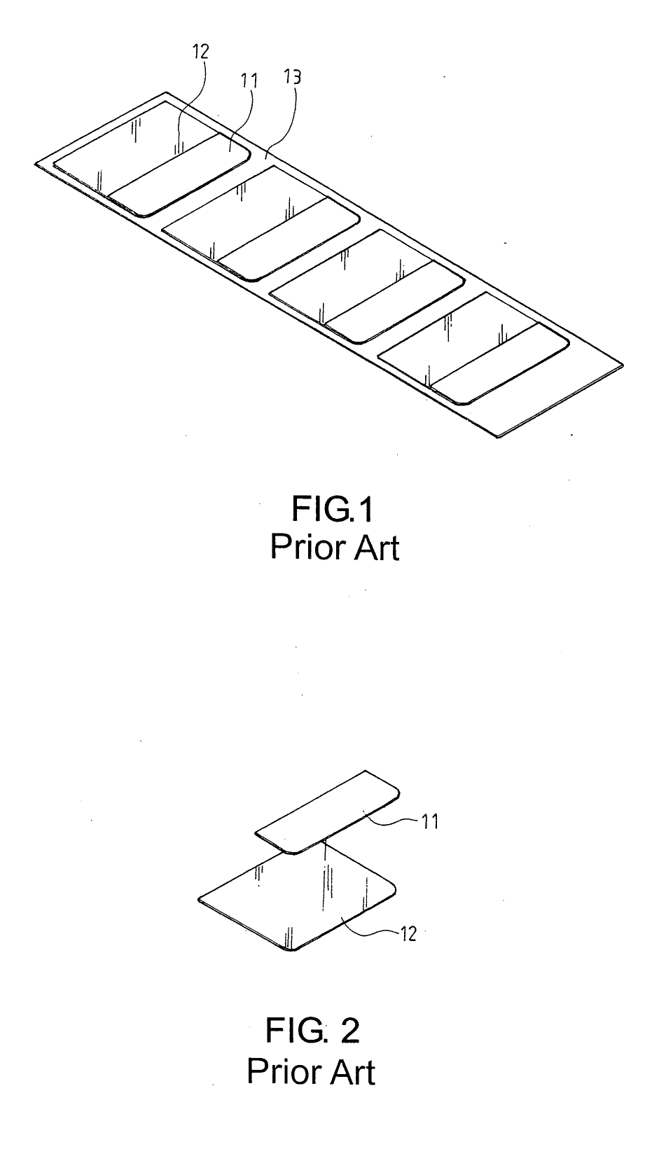

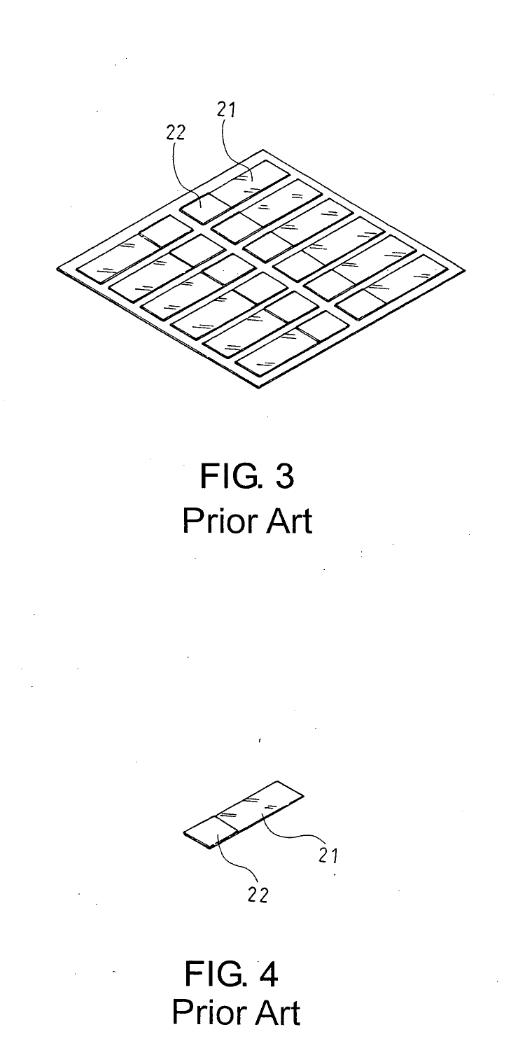

### DETAILED DESCRIPTION OF THE PREFERRED EMBODIMENTS

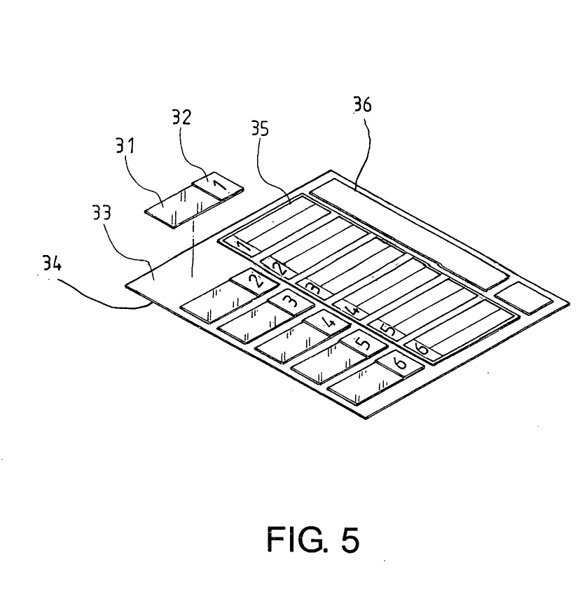

Referring to FIG. 5, the present invention is divided into four layers including a first layer, which is a simile paper; a second layer, which is a transparent paper; a third layer, which is a release bottom paper used by the transparent paper; and a fourth layer, which is a release paper. The four layers comprises primarily the transparent paper (side labeling paper) 31 which is printed with a pattern, the simile paper (side labeling paper) 32 which is printed with multiple variations of colors, and a simile labeling paper 36 which is used in a back ridge of folder. The transparent paper (side labeling paper) 31 is used as a bottom, the simile paper (side labeling paper) 32 is used as a top, and they are fed in and printed at the same time. After the transparent paper 31 and the simile paper 32 are affixed together, they are formed once with a guillotine molding to constitute the aligned stickers with multiple variations of colors, such that a consecutive operation of manufacturing the stickers can be more efficient.

The aforementioned sticker can be affixed to a release bottom paper 33 of a transparent paper, wherein a back side of the transparent paper (side labeling paper) 31 is coated with a weak glue of a strong stickiness, and a bottom of the release bottom paper 33 of transparent paper is provided with a release paper 34 of bottom paper 33. Therefore, after the release paper 34 of bottom paper 33 is torn off, the sticker can be affixed to an inner page of the folder, which is convenient in affixing. Referring to FIG. 5, the sticker can also be affixed to the simile labeling index papers 35, 36 having a same color as that of the simile paper (side labeling paper) 32, to facilitate a labeling. In addition, the sticker can be written with a water pen due to a design of the simile paper (side labeling paper) 32.

In usage, the present invention is provided with at least the following advantages as compared to a conventional sticker:
1. As the weak glue of strong stickiness is used, the present invention can be affixed repeatedly, and is rather robust after being affixed without being easily fallen off.
2. When the release paper at the bottom of release bottom paper 33 of transparent paper is torn off, the present invention can be affixed to an inner page of the folder, such that the present invention can be affixed conveniently and repeatedly.
3. The simile labeling index paper 35 is also a simile paper, which can be used for indexing and recording, and can be used in contrast with the simile paper of transparent paper to facilitate a fast searching.
4. The transparent paper 31 and the simile paper 32 can be used for the purposes of indexing and categorizing, which enables a quicker data searching. In addition, the searching can be clearer to avoid a waste in time of searching. On the other hand, in using the product, the back side of release paper 34 of bottom paper 33 can be printed with an operational instruction, which can also serve as an advertisement.
5. The simile labeling paper 36, which is located at a right side of the release bottom paper 33 of transparent paper and is used in the back ridge of folder, can be torn off to be affixed to the back ridge of folder, which can facilitate writing, comparing, and checking, and can be affixed repeatedly.
6. As the simile paper (side labeling paper) 32 can be written with the water pen, it is very convenient in marking notes, and can achieve an eco-purpose by not using the oily pen.

In addition, the manufacturing method of present invention is not required to be in a straight direction; therefore, multiple variations of colors can be printed, and the alignment, combination, and orientation of colors will not be limited.

On the other hand, the manufacturing process of present invention is a consecutive operation, which is provided with high production efficiency, and therefore is a practical design.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A sticker structure including a release paper of transparent paper which is printed with a pattern, and a simile paper which printed with multiple variations of colors, wherein the transparent paper is used as a bottom, the simile paper is used as a top, and they are fed in and printed at the same time; after the transparent paper and the simile paper being affixed together, the aligned stickers with multiple variations of colors being constituted by forming once with a guillotine molding.

2. The sticker structure according to claim 1, wherein a back side of the release paper is coated with a weak glue of strong stickiness, such that the sticker is affixed to different objects, and is affixed repeatedly.
